(19) United States
(12) Patent Application Publication
(10) Pub. No.: US 2007/0264972 A1
(43) Pub. Date: Nov. 15, 2007

(54) METHOD AND APPARATUS FOR A CALL TASK MANAGER IN A MOBILE COMMUNICATION DEVICE

(75) Inventor: JUERGEN M. STARK, GLENCOE, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/746,966

(22) Filed: May 10, 2007

Related U.S. Application Data
(60) Provisional application No. 60/747,233, filed on May 15, 2006.

(51) Int. Cl. H04M 3/16

(52) U.S. Cl. 455/410

(57) ABSTRACT

A method for creating and managing an executable call list in a mobile communication device includes: receiving in a mobile communication device a plurality of inputs each indicating that an entry corresponding to the input should be created in an executable call list; responsive to the plurality of received inputs, automatically creating in the mobile communication device, a corresponding plurality of entries in the executable call list, each entry including at least a name of a person to be called and at least one telephone number for executing the call; and removing an entry from the executable call list based on a call being executed to the person included in the entry by connecting over a network to a communication device used by the person.

### FIELD OF THE INVENTION

The present invention relates generally to applications running on a mobile communication device and more specifically to an application that creates and manages an executable call list in the mobile device.

### BACKGROUND OF THE INVENTION

Some users of mobile communication devices make numerous calls both personal and work-related on any given day. In making these calls, the user generally implements some known method of keeping track of and prioritizing calls that the user needs to make, but those known methods are not necessarily the most efficient or the most effective. For example, the user could rely on his or her memory to determine who the user should call and in what order. However, a very busy user would typically not be able to remember all of the persons needing to be called. The user could alternatively create a prioritized call list external to the mobile communication device and begin calling people on the list in the order of priority. However, this may be a cumbersome task for the user, especially if the user is driving a vehicle. Moreover, when the user is mobile there is also no easy way to update the list if, for example, the user receives an important call at the office that requires follow-up.

Thus, it would be useful to have a call task manager integrated with the mobile communication device that could receive inputs and, based thereon, create and manage an executable call list to assist the user in prioritizing and executing calls that he or she needs to make.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a mobile device in accordance with embodiments of the present invention;

FIG. 2 illustrates a flow diagram of a method for managing and organizing an executable call list in a mobile device in accordance with an embodiment of the present invention;

FIG. 3 illustrates a mobile device in communication with a remote device, the mobile device having a call manager in accordance with embodiments of the present invention; and

FIG. 4 illustrates a flow diagram of a method, in accordance with an embodiment of the present invention, for executing an autopilot protocol for calling persons on the executable call list.

### DETAILED DESCRIPTION OF THE INVENTION

Before describing in detail embodiments that are in accordance with the present invention, it should be observed that the embodiments reside primarily in combinations of method steps and apparatus components related to a method and apparatus for a call task manager. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for a call task manager described herein. The non-processor circuits may include, but are not limited to, a radio receiver, a radio transmitter and user input devices. As such, these functions may be interpreted as steps of a method to perform the call task manager described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language. Moreover, an embodiment of the present invention can be implemented as a computer-readable storage element having computer readable code stored thereon for programming a computer to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, an outbound call manager functionality on a mobile communication device is described. This functionality may be implemented as a software application running on a mobile communication device to create and manage an executable call list comprising entries associated with persons that a user desires to call. Various embodiments regarding how entries are initially created, are deleted and are modified in the executable call list as well as embodiments regarding how calls are executed to persons on the list are described below by reference to the accompanying figures. In implementing the teachings herein a user can, for example, more efficiently and effectively manage and prioritize a list of calls to be made from the user's cell phone. Those skilled in the art will realize that the above recognized advantages and other advantages described herein are merely illustrative and are not meant to be a complete rendering of all of the advantages of the various embodiments of the present invention.

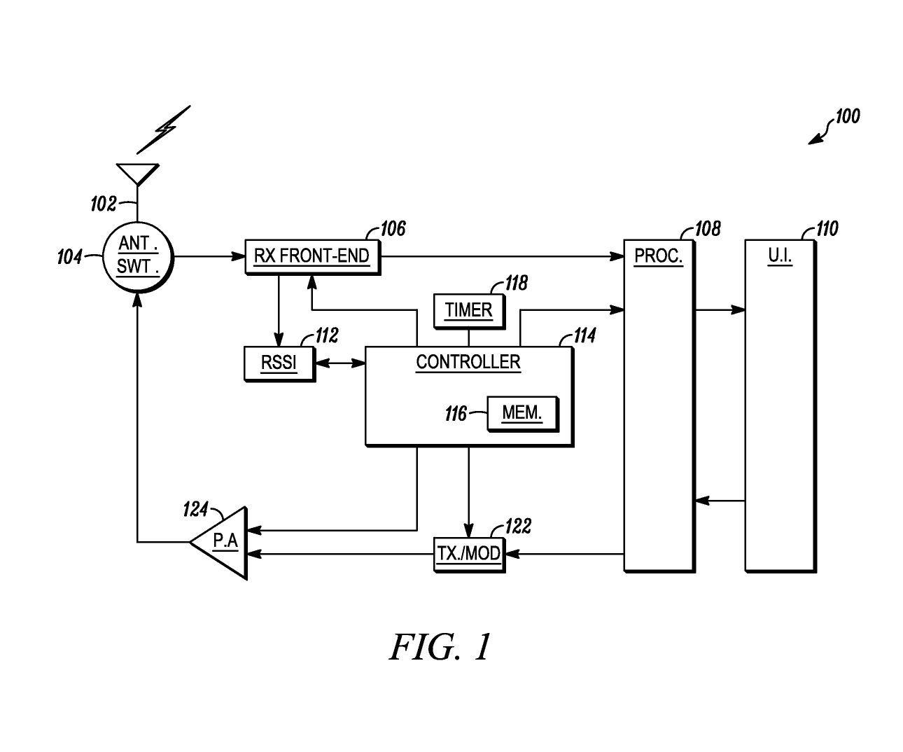

Referring now to the drawings, and in particular FIG. 1, a block diagram of a wireless communication unit also referred to herein as a mobile communication device or in abbreviated form a mobile device, in accordance with an embodiment of the present invention, is shown and generally indicated at 100. Mobile device 100 can be any type of wireless communication device such as, for instance, a mobile telephone handset, a personal digital assistant (PDA), and the like. Moreover, mobile device 100 can be configured to communicate over any number of networks including, but not limited to a wireless network that can be, for example, a wireless metropolitan area network (WMAN), a wireless local area network (WLAN), a wireless personal area network (WPAN), a global system of mobile communications (GSM) network, a personal communication system (PCS) network, a mobitex network, a general packet radio service (GPRS) network, a code division multiple access (CDMA) network, a universal mobile telephone service (UMTS) network, an advanced mobile phone system (AMPS) network, and the like. The mobile device 100 comprises an antenna 102 coupled to a duplex filter or antenna switch 104 that provides isolation between receive and transmit chains within the mobile device 100, also, respectively, referred to herein as transmitter and receiver apparatus.

The receiver chain, as known in the art, includes receiver front-end circuitry 106 (effectively providing reception, filtering and intermediate or base-band frequency conversion). The front-end circuitry 106 is serially coupled to a signal processing function 108. An output from the signal processing function 108 is provided to a user interface 110, which in a receiving context comprises a suitable output device, such as a screen and/or speaker. The receiver chain also includes received signal strength indicator (RSSI) circuitry 112, which in turn is coupled to a controller 114 that maintains overall mobile device control. The controller 114 may therefore receive bit error rate (BER) or frame error rate (FER) data from recovered information. The controller 114 is also coupled to the receiver front-end circuitry 106 and the signal processing function 108 (generally realized by a digital signal processor (DSP)). In some embodiments, the controller functionality may be implemented by the signal processor function 108, as would be appreciated by a person skilled in the art.

The controller 114 is also coupled to a memory device 116 that selectively stores operating regimes, such as decoding/encoding functions, synchronization patterns, code sequences, message handling software, and the like. A timer 118 is operably coupled to the controller 114 to control the timing of operations (transmission or reception of time-dependent signals) within the mobile device 100, particularly with regard to establishing a telephone connection, or transmitting and receiving an e-mail, a short message service (SMS) message, an instant message, an Internet Protocol (IP) based message, and the like, in accordance with embodiments of the present invention.

As regards the transmit chain, this essentially includes an input device such as a keypad and/or microphone, of the user interface 110. The user interface 110 is coupled in series via the signal processing function 108 through transmitter/modulation circuitry 122 and a power amplifier 124 to the antenna 102. The transmitter/modulation circuitry 122 and the power amplifier 124 are operationally responsive to the controller 114, and as such are used in the establishing of a telephone call, and/or transmission of a message.

A skilled artisan will appreciate that the signal processing function in the transmit chain may be implemented as distinct from a signal processing function in the receive chain. Alternatively, a single processor 108 may be used to implement processing of both transmit and receive signals, as shown in FIG. 1. Clearly, the various components within the mobile device 100 can be realized in discrete or integrated component form, with an ultimate structure therefore being merely dependent upon the prevailing design considerations.

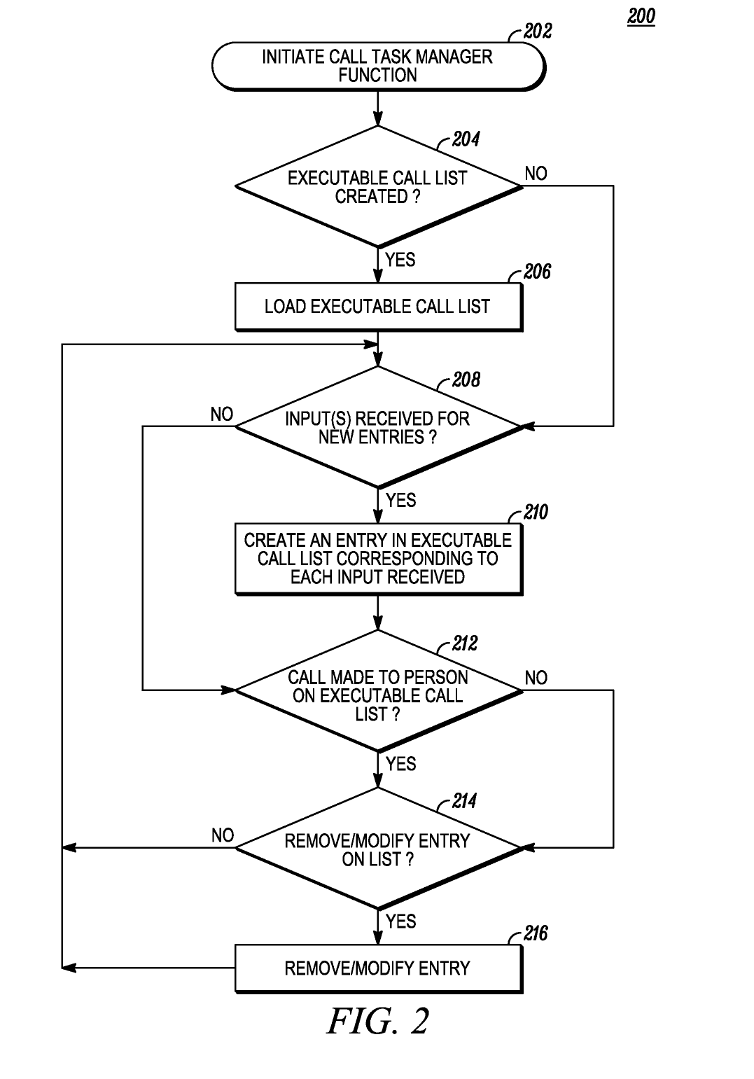

Turning now to FIG. 2, a flow diagram of a method for maintaining an executable call task list in the mobile device 100 in accordance with embodiments of the present invention is shown and generally indicated at 200. This method and the method illustrated by reference to FIG. 4 may, in one embodiment, be implemented as a software application saved in memory 116 and executed by controller and/or processor 108. The software application can be written using any suitable programming language such as, but not limited to, C++. However, skilled artisans will realize that parts or all of the functionality of these methods and other functionality realized in accordance with the teachings herein may be implemented by one or more of a FPGA, ASIC, state machine, and the like. However, for the sake of simplicity the embodiments described herein are described as being carried out by a software application referred to in abbreviated form as “the application”.

An outbound call task manager function, which is implemented by the application, is initiated at 202. This may occur, for example, upon power-up of the mobile device 100 or in response to an input by the user into the user interface, the user input thereby causing a command to be issued to the mobile device to execute the application. At 204, the application determines whether an executable call list has been created and is stored in memory 116 and if so loads the executable call task list at 206 so that it is viewable on a screen by the user, and the application proceeds to 208. If no executable call list currently exists in memory, the application proceeds directly to 208. As referred to herein, an executable call list is a list comprising one or more entries, wherein each entry includes at least a name of a person to which the user desires to make an outbound call connecting over a communication network the mobile device 100 (or some other device remote to the mobile device and used by the user) to a communication device used by the person included in the entry. Each entry further comprises at least one telephone number, e.g., a primary telephone number and one or more secondary telephone numbers, which can be used to call and connect to the user's communication device.

At 208, the application determines whether one or more input are received, wherein each input is associated with a command or otherwise indicates to the application to create an entry corresponding to the input in the executable call list. Such inputs can be sent from a number of illustrative sources. For example, in accordance with one implementation the user could issue a command to create an entry in the executable call list. The user can do this in a number of ways including, but not limited to, manually creating an entry in the list using the keyboard or some designated key on the user interface 110, sending a command using a device remote to mobile device 100 (also referred to herein in abbreviated form as a “remote device”), and sending a command using a web-based application or another separate application running on the mobile device 100 or the remote device, and the like.

In one embodiment, the user enters a calendaring function or to-do task function on mobile device 100, which includes tasks associated with phone calls that the users needs to make. The user uses the calendaring and/or task function to generate inputs to the application to create corresponding entries in the executable call list. In another embodiment based on a web-based application running on the mobile device 100, the user uses a designated link of a website to add an entry to the user's executable call list. For example, the user could be browsing a product site that has a call for more information link. By hitting that link, the user sends a command to the application to create an entry in the user's executable call list.

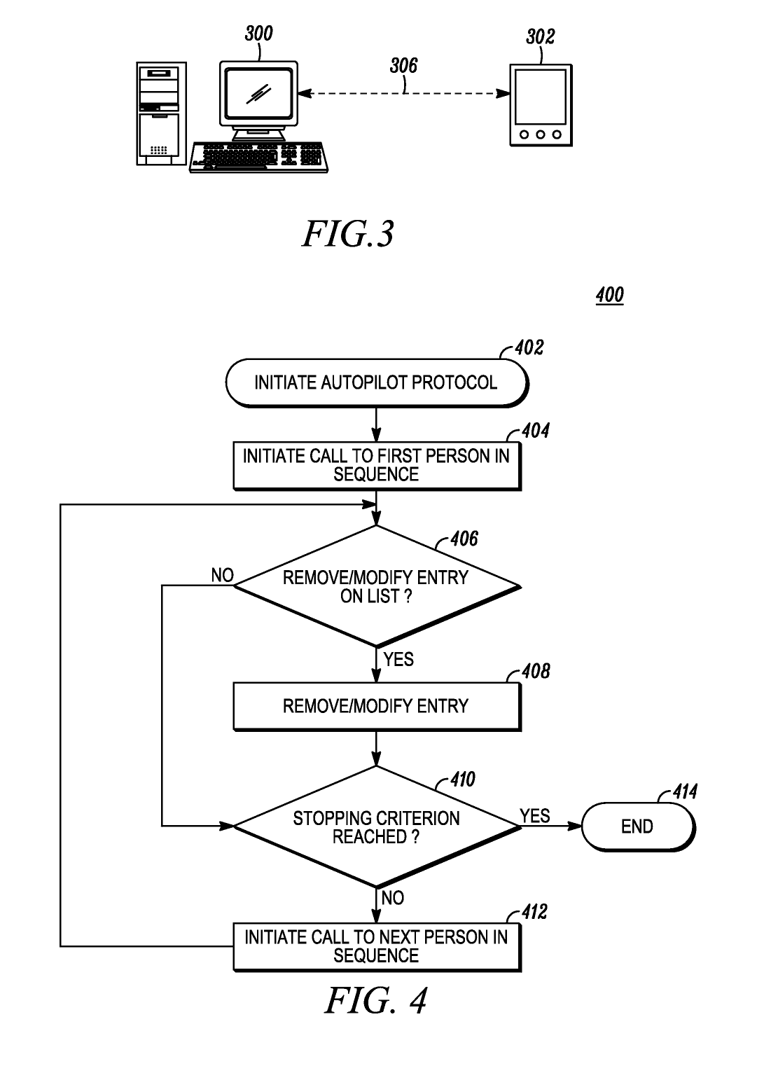

Referring momentarily to FIG. 3, illustrated therein is a mobile device 302 configured in accordance with mobile device 100 and performing an outbound call task manager function in accordance with method 200. Also shown is a remote device 300 that is connected to mobile device 302 using any suitable wireline or wireless link, as is well known in the art. In this illustration, the remote device is a personal desktop computer, but may be any suitable device capable of sending messages to and receiving messages from mobile device 302, including, but not limited to, a laptop computer. Regarding the command sent using the remote device and received in the mobile device's receiver apparatus, this command could, for instance, be included in a message from the remote device in accordance with any suitable messaging protocol—with the message having the required format and addressing sequence to generate the input command to the application. The message may be, for example, a SMS message, an instant message, an email message, an IP-based message and a message sent in accordance with any predefined proprietary or standard messaging protocol. The user could further send commands to the application using a calendaring function, Microsoft Outlook-based transport mechanisms such as synchronization of Outlook Tasks or other software application in the remote device similar to those described above by reference to the mobile device 100. In addition, not only can the user send such remote commands, the user can authorize one or more additional persons referred to herein as an “authorized person” (such as an assistant or a spouse, for instance) to issue commands via a remote device to create entries in the user's executable call list.

Turning again to 208 of method 200 illustrated in FIG. 2, input or commands to the application could be generated from a received call log in the mobile device, where those calls that were received in the mobile device but were unanswered are automatically added to the executable call list, or, alternatively, are added after prompting to and confirmation by the user via the user interface 110. Moreover, the user could manually add entries to the executable call list corresponding to one or more of the received and unanswered calls. In yet another embodiment, inputs or commands to the application are generated based on a set of one or more predetermined call task management rules. For example, an input could be automatically generated from a task created using another application in the mobile device, wherein the task includes the name of a person and a telephone number to call the person. Also, an input could be automatically generated associated with calling a predetermined person, such as a spouse for instance, at a given time every day. Skilled artisans will readily realize that this is by no means an exhaustive list of such programmatic rules but merely a few examples of such.

Upon receiving the inputs in 208, the application automatically generates the corresponding entries in the executable call list, at 210. As stated earlier, at a minimum each entry includes the name of a person to be called and at least one telephone number for calling the person. Each entry could further, optionally, include a date and/or time for executing the call to the person included in the entry, descriptions or notes associated with the entry (for instance the subject of the call) or any other additional information as desired. This additional data can be included with the inputs 208 or added at another time. Date and time data for one or more entries could be added by default (for example to initiate call at a certain time every day, such as when the user will be in a car driving).

In one embodiment, the application could generate a reminder to the user based on the date and time included in the entry. For example, on the date and at a predetermined time before the designated time, the application could vibrate the mobile device, create a tone, ring or audible message or display on the screen, or otherwise indicate to the user that the person in the entry is scheduled to be called at the date and time included in the entry and can further prompt the user to confirm that the mobile device should proceed with initiating the call. In addition, entries created in the executable call list based on remote commands could be flagged to cause the application notify the user via the mobile device (e.g., via a ring, buzz, audible message, and the like) to, for example, enable the user to determine if an urgent item has been added.

At 212, the application determines whether a call has been executed to a person included in an entry on the executable call list. For purposes of this discussion, a call is executed or made when a connection is made over a communication network between a communication device used by the user and a communication device used by the person included in the entry, for a sufficient amount of time for the user and the person to communicate using their respective devices. In one illustrative embodiment such as when the mobile device 100 initiates the call using one of the telephone numbers included in the entry, the application automatically determines that such a call has been made when the connection exists for a length of time that is greater than a predetermined threshold, say ten seconds. In another illustrative embodiment such as when the users calls the person from a communication device other than the mobile device 100 like a landline telephone in the user's office, the user notifies the application that the call has been made via the user interface of the mobile device 100 or via a remote device using any suitable means (such as one of the messaging means described above).

In either case, whether a call is made to a person included in an entry in the executable call list or not, the application determines whether to remove or edit an entry on the list, at 214. Take the situation where the application determined in 212 that a call to a person included in an entry on the list was made either using the transmit chain of mobile device 100 or a remote communication device. In one embodiment at 214, the application prompts the user via the user interface for a response or command as to whether to remove the entry. For example, the application could ask the user if the prior call resulted in the completion of a “Call Task”, and if the user answers affirmatively, the application removes the entry corresponding to that call.

If the application does not remove the entry, it could instead modify the entry by including an indication (e.g., a completed task indication) in the entry that the call was made. Where the user calls the person using a different communication device, the application removes or modifies the entry in response to user input that may be, for example, a deletion/modification indication in the above-described user message/command from a remote communication unit notifying the application that the user made the call (or completed the task).

As indicated above, the application can remove or modify an entry in the executable call list for reasons other than a call being made to a person on the list. Examples of criteria for modifying or removing an entry include, but are not limited to: a command from the user via for instance the user interface, a different application (web-based or otherwise) running on the mobile device or a remote device, etc.; a command from an authorized person using a remote device; and a predetermined set of call management rules, for instance, the application could be configured to automatically removed an entry where a call has not been executed to the person included in the entry for a time period that exceeds a predetermined threshold, to further aid in keeping the executable call list current. In any case, where the application determines that an entry should be deleted or modified, the application proceeds to execute this function at 216, wherein the application then returns to 208 in the process. The application continues this loop (not necessarily in the steps as ordered) until the application is disabled, for example, by user input or by the user turning off the communication device.

In further embodiments, the application may execute additional optional functionality to manage and organize the executable call list. In one illustrative embodiment, the application can arrange, based on a number of criteria, the entries in the list in a given order for executing calls to all or some of the persons on the list. For example, the entry can indicate a certain priority category for calling the person such as high, medium, low or a specific number ranking in the list, etc. Priority can, further, be: assigned manually by the user, indicated in the input received by the application at 208 (FIG. 2); associated with a predetermined category or type of entry (e.g., entries associated with a WORK category being automatically assigned a higher priority than entries associated with a PERSONAL category, or entries received from a given predetermined source such as the user or the user's assistant being given the highest priority); and based on the name, telephone number, date and/ time included in the entry.

In another illustrative embodiment, the user or an authorized person could command or request the application to generate a list based on the executable call list, to be displayed on the user's device (e.g., on a home screen) or exported to a remove device. Lists having a variety of data can be generated including, but not limited to: a list of all entries associated with the executable call list, for instance, all entries that were included in the list over a defined time period; a list of all current entries in the executable call list including both executed calls and those that have not yet been executed; a list of entries removed from the executable call list over a selected time period; a list of entries removed from the executable call list over a selected time period, wherein a call was executed to the person included in the entry; and a list of all current entries in the executable call list wherein a call to the person included in the list has not been executed (e.g., a “Pending Calls” list). Other formats of lists not specifically mentioned are, of course, included within the scope of the teachings herein. In addition, during this process if the application cannot connect to the person using the primary number it could attempt the call using one or more secondary numbers, either automatically or after user confirmation.

When the user uses the mobile device 100 to make a call to a person included in an entry on the user's executable call list, the call could either be manually initiated by the user or automatically initiated by the mobile device 100. The user could, for example, manually initiate a call by reviewing the entries in the list on the display screen and selecting a specific entry that includes the name of the person the user desires the mobile device to call using one of the numbers included in the entry. Alternatively, the user could initiate a so-called “autopilot” feature or protocol of the application.

FIG. 4 illustrates an illustrative method 400 for implementing this autopilot feature. In accordance with the illustrative implementation described as follows, the autopilot feature can provide a completely hands-free environment using voice prompts and speech recognition, for instance, for the user to execute a sequence of calls to persons in the user's executable call list. For example, in one illustrative embodiment, the user can use a technology, such as Bluetooth, to communicate with the application without having to press any buttons on the mobile device. However, those of ordinary skill in the art will realize that the autopilot feature can alternatively, be implemented in whole or part by the user manually entering commands into the mobile device.

The user commands the application to initiate the autopilot feature at 402 by speaking into a Bluetooth headset to the application to “initiate autopilot feature”. In response thereto, the application selects a first entry from the executable call list to initiate a call at 404 to the person in the entry using the primary telephone number included in the entry. The application could automatically initiate the call or provide a voice prompt to the user to confirm that the application should call the person at the intended telephone number. Based on whether the application was or was not successful in executing the call (e.g., whether or not a Call Task is complete), the application determines at 406 whether to remove or edit the entry. The application can perform this step similarly to its execution of 212 and 214 (FIG. 2), with the addition that 406 is performed via voice prompts and voice recognition with the user.

If the application determines that the entry should be modified, it does so at 408, wherein it determines at 410 whether to terminate the autopilot protocol based on whether a stopping criterion has been reached. The stopping criterion could be for example that the application has attempted to contact and/or has succeeded in contacting all of the persons on the executable call list, that the user has powered off the mobile device or that the user has issued a voice command to exit the autopilot feature. In that case, the process ends at 414, otherwise the process continues at 412, wherein the application initiates a call to the next person in the sequence and returns to 406. In addition, during this process if the application cannot connect to the person using the primary number it could attempt the call using one or more secondary numbers, either automatically or after user confirmation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter

What is claimed is:

1. A method for creating and managing an executable call list in a mobile communication device, the method comprising:
receiving in a mobile communication device a plurality of inputs each indicating that an entry corresponding to the input should be created in an executable call list;
responsive to the plurality of received inputs, automatically creating in the mobile communication device, a corresponding plurality of entries in the executable call list, each entry comprising at least a name of a person to be called and at least one telephone number for executing the call; and
removing an entry from the executable call list based on a call being executed to the person included in the entry by connecting over a network to a communication device used by the person.

2. The method of claim 1 further comprising removing an entry from the list based on at least one criterion other than a call being executed to the person included in the entry, wherein the at least one criterion comprises at least one of: a command from the user; a command from a remote device; a predetermined set of call task management rules; a command from an application executed on the mobile communication device; and a command from a web-based application.

3. The method of claim 1, wherein the call is executed by the mobile communication device calling the at least one telephone number included in the entry.

4. The method of claim 1, wherein at least one of the plurality of entries is created using a received input from a remote device, the method further comprising notifying a user via the mobile communication device of the at least one entry created using the received input from the remote device.

5. The method of claim 3, wherein the entry is removed from the executable call list in response to user input into a user interface coupled to the mobile communication device.

6. The method of claim 3 further comprising:
receiving a command to initiate a predetermined protocol to execute a sequence of calls to persons included in at least a portion of the entries on the executable call list;
initiating a first call in the sequence to a first person included in a first entry in the executable call list; and
if the end of the sequence of call has not been reached, executing a next call in the sequence until a stopping criterion is reached.

7. The method of claim 6 further comprising:
prompting the user for confirmation to initiate each call in the sequence of calls prior to initiating the call.

8. The method of claim 7, wherein the user audibly receives the prompting and orally gives the confirmation to initiate the call.

9. The method of claim 1, wherein the call is executed using a communication device other than the mobile communication device, and the entry is removed from the executable call list further based on one of a command from the user using a user interface coupled to the communication device and a command from a remote device.

10. The method of claim 1, wherein the plurality of inputs is generated based on at least one of:
a received and unanswered call in the mobile communication device;
a command from the user;
a command from a remote device;
a predetermined set of call task management rules;
a command from an application executed on the mobile communication device; and
a command from a web-based application.

11. The method of claim 10, wherein the command from the remote device is included in a message from the remote device.

12. The method of claim 11, wherein the message comprises one of:
a Short Message Service message;
an instant message;
an email message;
an internet protocol-based message;
a message sent from a software application running on the remote device;
a message sent using a Microsoft Outlook-based transport mechanism; and
a message sent in accordance with a predefined protocol.

13. The method of claim 12, wherein the message is sent by one of the user and a person authorized by the user.

14. The method of claim 1 further comprising forwarding at least one list that is based on entries associated with the executable call list to at least one of a screen on the mobile communication device and a remote device.

15. The method of claim 1, wherein the at least one list comprises one of:
a list of all entries associated with the executable call list;
a list of all current entries in the executable call list;
a list of entries removed from the executable call list over a selected time period;
a list of entries removed from the executable call list over a selected time period, wherein a call was executed to the person included in the entry; and
a list of all current entries in the executable call list wherein a call to the person included in the list has not been executed.

16. The method of claim 1 further comprising arranging, based on at least one criterion, the entries in the executable call list in an order for calling the person included in each entry.

17. The method of claim 16, wherein the at least one criterion comprises at least one of:
an indication of priority associated with each entry;
the name of the person included in each entry;
a date associated with each entry;
a time associated with each entry;
the at least one telephone number included in each entry;
type of call; and
at least one predetermined category.

18. The method of claim 1 further comprising modifying at least one of the entries in the executable call list.

19. The method of claim 1, wherein the at least one telephone number comprises a primary telephone number and a secondary telephone number.

20. The method of claim 1, wherein each entry further comprises a time and date for executing a call to the person included in the entry.

21. The method of claim 20 further comprising providing a reminder to the user based on the time and date included in the entry prior to the call being executed to the person included in the entry.

22. A mobile communication device comprising:
receiver apparatus receiving from a remote device at least a portion of a plurality of inputs each indicating that an entry corresponding to the input should be created in an executable call list;
a processing device coupled to the receiver and, responsive to the plurality of received inputs, automatically creating in the mobile communication device a corresponding plurality of entries in the executable call list, each entry comprising at least a name of a person to be called and at least one telephone number for executing the call; and
transmitter apparatus coupled to the processing device and executing a call to a person included in an entry in the executable call list using the at least one telephone number included in the entry, wherein the processing device further removing an entry from the executable call list upon the transmitter executing the call.

23. A computer-readable storage element having computer readable code stored thereon for programming a computer to perform a method for creating and managing an executable call list in a mobile communication device, the method comprising:
receiving in a mobile communication device a plurality of inputs each indicating that an entry corresponding to the input should be created in an executable call list;
responsive to the plurality of received inputs, automatically creating in the mobile communication device, a corresponding plurality of entries in the executable call list, each entry comprising at least a name of a person to be called and at least one telephone number for executing the call; and
removing an entry from the executable call list based on a call being executed to the person included in the entry by connecting over a network to a communication device used by the person.
